(19) United States
(12) Patent Application Publication
(10) Pub. No.: US 2008/0173499 A1
(43) Pub. Date: Jul. 24, 2008

(54) Window coverings

(75) Inventor: Reginald C. Allsopp, Stockport (GB)

Correspondence Address: WOLF GREENFIELD & SACKS, P.C., 600 ATLANTIC AVENUE, BOSTON, MA, 02210-2206, US

(73) Assignee: Louver-Lite Limited, Hyde Cheshire (GB)

(21) Appl. No.: 12/009,610

(22) Filed: Jan. 18, 2008

(30) Foreign Application Priority Data
Jan. 18, 2007 (GB) GB 0700967.3

(51) Int. Cl. F03G 1/08; F16D 1/02

(52) U.S. Cl. 185/40 R; 403/14

(57) ABSTRACT

A window blind assembly is provided for use with a roller blind. The assembly comprises a charging element; a retaining element; and an energy storage system operatively connected therebetween. The energy storage system comprises a plurality of springs and the charging system is adapted to rotate relative to the retaining element such that the energy storage system is charged upon closure of the blind and the stored energy is released during the opening of the blind, whereby the opening of the blind is assisted by the release of the stored energy from the energy storage system. The springs are connected in series such that they are axially spaced from each other and adjacent ends of the springs are connected together via a connector located therebetween, wherein the adjacent ends of the springs are each coupled to a respective end of the connector and rotation of one spring relative to the other is prevented.

### BACKGROUND OF INVENTION

The present invention relates to window blind systems and in particular, to roller blinds including such systems.

Blinds for windows and the associated mechanisms for covering and uncovering the window have been known in the art for some time. An example of one such window blind is a roller blind which typically comprises a blind substrate (e.g. a fabric material) wound around a roller tube which is rotated in use by a winding mechanism. Operating the winding mechanism acts to lower or raise the blind accordingly.

In the case of large blinds, the substrate may be heavy, making the blind difficult to raise manually. It is therefore desirable to incorporate a mechanism to aid the raising of such a blind. One example of such a mechanism is disclosed in AU200053651, which describes a spring mechanism incorporated within the roller tube. Upon the lowering of the blind, the spring is charged with potential energy which is released upon the raising of the blind, thereby aiding the operation of the winding mechanism.

However, a problem with this type of system is that the spring used in the assembly must be chosen in relation to the size of the blind (i.e. the length of the roller tube) and the weight of the substrate. If the size of the spring is not chosen carefully, it is likely that the energy needed to charge the spring will be too great, causing difficulty in lowering the blind, or, conversely, the spring will deform too easily when lowering the blind and there will not be sufficient stored energy to provide the required assistance in raising the blind. To account for the above factors, it would be necessary for roller blind manufacturers to provide a spring which was specific to each blind they produced and took into account the length of the roller tube and the weight of the substrate.

It will be appreciated that blinds such as roller blinds can be made to almost any conceivable width and drop. As such, a supplier would either have to carry an enormous range of different springs to cater for each individual roller blind or have the springs made to order for each roller blind produced. Alternatively, they would have to use a spring which was not ideally suited to the respective roller blind and suffered from one of the problems mentioned above to some extent.

In addition, the rotation of the spring within the roller tube often generates significant noise, which can be disconcerting to the user and is undesirable.

U.S. Pat. No. 3,412,423 discloses a roller door mechanism for a van or lorry rather than a window blind mechanism. In addition, it does not disclose a connector element located between adjacent ends of two or more springs.

U.S. Pat. No. 5,775,619 discloses a protective cover for machinery rather than a window blind mechanism. In addition, the springs of the roller cover overlap each other and are arranged about a common shaft. There is no disclosure of a connector element located between axially spaced springs.

GB2263728 discloses a spring balancer for a roll-up door rather than a window blind mechanism. In addition, the spring arrangement is such that the springs overlap each other and are coupled by a common shaft, rather than via a connector located between axially spaced springs.

U.S. Pat. No. 6,123,140 discloses a roller blind mechanism comprising multiple springs. However, the springs overlap each other and are not arranged in series. As such, there is no disclosure of adjacent ends of two springs being coupled by a connector located therebetween.

US 2006/0137837 and U.S. Pat. No. 1,392,918 both disclose spring assist units which comprise a plurality of springs. However, the springs in both of these documents are arranged in parallel, rather than in series, and as such do not have adjacent end portions.

This invention seeks to address or ameliorate at least some of the problems associated with the prior art.

### SUMMARY OF INVENTION

According to a first aspect of the invention, there is provided a window blind assembly for use with a roller blind, the assembly comprising:

a charging element;

a retaining element; and

an energy storage system operatively connected therebetween, wherein the energy storage system comprises a plurality of springs and the charging system is adapted to rotate relative to the retaining element such that the energy storage system is charged upon closure of the blind and the stored energy is released during the opening of the blind, whereby the opening of the blind is assisted by the release of the stored energy from the energy storage system; characterised in that the springs are connected in series such that they are axially spaced from each other and adjacent ends of the springs are connected together via a connector located therebetween, wherein the adjacent ends of the springs are each coupled to a respective end of the connector and rotation of one spring relative to the other is prevented.

By using a plurality of springs connected in series, it is possible to provide an energy storage system of the correct length and energy storage capacity simply by selecting the appropriate combination of individual springs. In addition, it has been found that the use of multiple springs in series significantly reduces and often eliminates the unwanted noise generated during use.

In embodiments of the invention defined herein, the adjacent ends of the springs may be releasably coupled to respective ends of the connector.

In a further embodiment of the invention as defined anywhere above, the or each connector comprises a body portion and two end portions, wherein the end portions are adapted to engage and optionally retain an end of a respective spring.

In this way, the body portion may be located between the adjacent springs and can act as a spacer between them, while the end portions engage the adjacent springs and prevents relative rotation between them.

In a yet further embodiment of the invention as defined anywhere above, each spring includes a pair of opposed ends and each end is provided with an engagement element adapted to engage a respective end portion of the connector. The engagement elements may, for example, be tangs formed at the ends of the springs.

The springs may be helical springs (also known as coil springs) of a known type. Such springs are readily available in different lengths and energy storage capacities. Where the springs are helical springs and include an engagement element at each end, this may be formed by a projecting end portion (tang) of the winding which is adapted to engage an end portion of a respective connector. Typically the projecting end portion will project inwardly. In such embodiments, the end portions of the connector may include an axial channel adapted to receive the inwardly projecting end portion of the winding.

In order to lock the connector to an end portion of the spring, an axial channel in the end portion may terminate in a circumferential channel disposed between the end portion of the connector and the body portion of the connector. The circumferential channel may extend between two stops wherein the angle defined between the stops is less than 360°, preferably between 30° and 270°. Thus, the inwardly projecting end portion or tang of the spring may slide longitudinally within the axial channel until it reaches the circumferential channel. At this point, the connector may be rotated relative to the spring, thereby moving the inwardly projecting end portion of the spring out of alignment or engagement with the axial channel and preventing de-coupling of the spring from the connector.

Once located within the circumferential channel, one of the stop surfaces of the circumferential channel engages the inwardly projecting end portion of a spring such that a rotational force or torque exerted on the spring is transmitted to the connector and may then be transmitted by the connector to a spring coupled with the other end of the connector.

The charging assembly of a roller blind typically comprises a winding mechanism. In an embodiment of the invention as defined anywhere above, the winding mechanism is operatively connected to a drive end of the energy storage system such that the winding mechanism is capable of rotating or causing to rotate the drive end of the energy storage system relative to the retaining element. A clutch may be included in the blind assembly, wherein the clutch has a first position in which the rotation of the blind is impeded or prevented, and second position in which the blind is free to rotate. The clutch may be displaced between the first and second positions. By impeding or permitting the rotation of the blind, the clutch also prevents or permits rotation of the charging assembly relative to the retaining element (and thus rotation of the drive end of the energy storage system of the energy storage system).

In an embodiment of the invention as defined anywhere above, the window blind assembly further comprises a tubular housing to house the energy storage system. The housing may be the roller tube of the roller blind. Thus, the energy storage system may be housed within the roller tube. In such embodiments, the tube rotates relative to two end fixings.

A drive end of the energy storage system may be coupled to the tubular housing such that rotation of the housing results in concurrent rotation of the drive end of the energy storage system. A fixed or stationary end of the energy storage system may be coupled to one of the end fixings such that the end fixing prevents rotation of the fixed or stationary end of the energy storage system.

The roller blind may include a coupling which couples together the roller tube and the drive end of the energy storage system. The coupling may be operatively connected to a winding mechanism of the blind via a clutch, such that operation of the winding mechanism causes the clutch to disengage (i.e. to permit rotation of the roller tube) and causes both the tube and the drive end of the energy storage system to rotate relative to the fixed end of the energy system. When the winding mechanism is stationary, the clutch is engaged such that it prevents unwanted rotation of the tube. Thus, the clutch may form part of the charging assembly.

In an embodiment of the invention as defined anywhere above, the clutch includes a fixed part, a rotating part and located therebetween a locking element having a lock position in which the rotating part is prevented from rotating relative to the fixed part, and a release position in which the rotating part may rotate relative to the fixed part. The fixed part may form part of the retaining element and the rotating part may form part of the charging assembly.

Optionally, the energy storage system further comprises at least one spacing element, the at least one spacing element being adapted to space the energy storage system from the interior wall of a tubular housing. The spacing element may comprise a collar which is adapted to at least partly surround one or more of the connectors and act as a bearing therefor. Alternatively, it may form a part of the or each connector.

According to second aspect of the invention, there is provided a connector for use with the window blind assembly as defined anywhere above, the connector comprising a body portion and two opposed end portions, the end portions being adapted to engage an engagement element of a respective spring such that relative rotation of adjacent springs connected by the connector is prevented.

Optionally, the body portion of the connector defined above includes at least one spacer element to space the end portions of the connector from a housing capable of housing the window blind assembly.

In a third aspect of the invention there is provided a coupling for securing the energy storage system to the retaining element as defined above, the coupling comprising a first connector element adapted to engage the retaining element and a second connector element adapted to engage the energy storage system. The second connector element may include an axial channel and a circumferential channel as defined above in connection with the connector.

In a fourth aspect of the invention, there is provided a securing assembly for preventing the unwanted decoupling of the retaining element from the energy storage system, wherein the securing assembly is adapted to cooperate with the coupling of the second aspect of the invention defined above. The securing assembly comprises a collar slidably carried by the coupling, the collar being capable of at least partly surrounding the first connector element, thereby preventing its release from the retaining element. The securing assembly may further comprise a retaining pin which is capable of being secured within axially aligned apertures through the collar and the first connector element.

It should be appreciated that the term “an embodiment of the invention” should be understood to refer to any embodiment or aspect of the invention as defined or described herein. Therefore, it should be understood that the features of specific embodiments can be combined with one or more other specific features described herein or be combined with any aspect or embodiment of the invention described herein. All such combinations of features are considered to be within the scope of the invention defined in the claims.

### BRIEF DESCRIPTION OF DRAWINGS

A detailed description of an embodiment of the invention will now be given by way of example only, with reference to the following figures:

FIG. 1: An exploded view of the internal components of a roller blind assembly according to the invention,

FIG. 2: A view of a centre pin connector, a collar and a retaining pin in accordance with an aspect of the invention, and

FIG. 3: A view of a spring connector.

### DETAILED DESCRIPTION

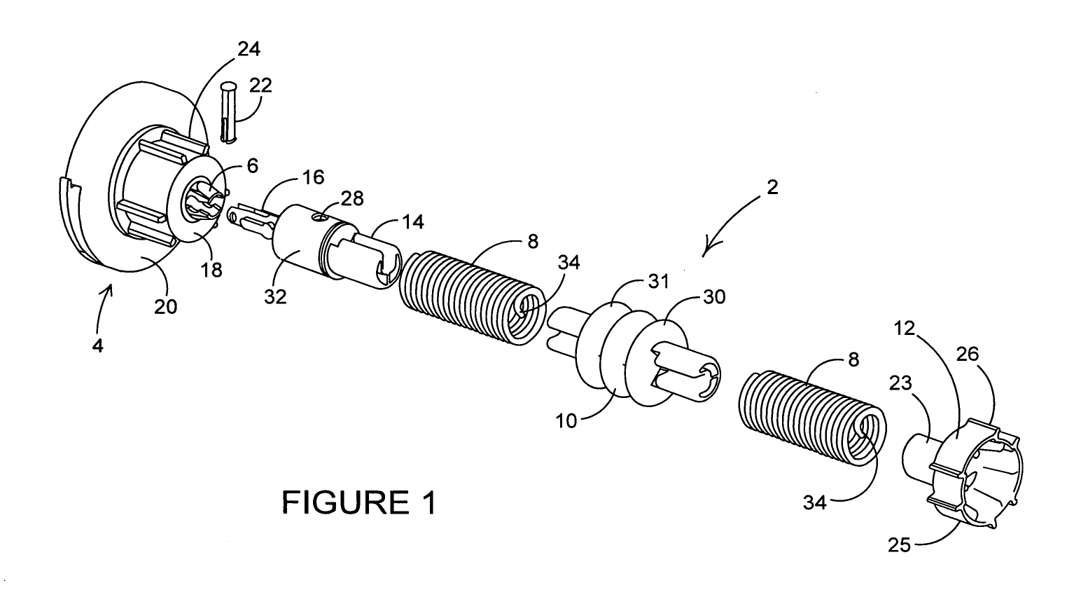

FIG. 1 shows some of the internal components of a roller blind according to the invention. Located within a roller tube (not shown) is an energy storage system 2 comprising two helical springs 8, a control end 4 and a drive coupling 12.

In the embodiment shown in FIG. 1, the helical springs 8 are connected together by a connector 10. However, a skilled person will appreciate that more than two springs could be used in accordance with the invention, where adjacent springs are joined by connectors.

The springs 8 are formed from a single winding of steel. Each end portion of the winding is formed so that it extends radially inwards to form an inwardly projecting end portion 34.

The control end is a known assembly and includes a toothed drive wheel (not shown) located within a housing 20 and arranged to rotate about a central shaft of the housing 20. The drive wheel includes a drive shaft projecting axially therefrom which partly overlies the central shaft of the housing 20. The drive shaft of the drive wheel is arranged to engage an inwardly projecting portion of a drive plug 18 which in use is located within the roller tube. Thus, rotation of the drive shaft via rotation of the drive wheel by a user causes the corresponding rotation of the drive plug 18. The drive plug 18 is secured within the roller tube in such a way that rotation of the drive plug 18 causes the roller tube to rotate and the blind to be raised or lowered according to the sense of the rotation.

In order to prevent the weight of the blind causing the roller tube to rotate unintentionally, a wrap spring clutch is located between the drive shaft of the drive wheel and the central shaft of the housing 20. The wrap spring clutch is arranged to permit rotation of the drive plug 18 by the drive wheel, but to prevent rotation of the drive wheel by the drive plug 18.

Thus, the clutch permits the intended rotation of the roller blind tube by an operator rotating the drive wheel via a chain or cord engaged with the teeth of the drive wheel, but prevents the unintended rotation of the roller blind, e.g. caused by the weight of the blind substrate (not shown).

The drive plug 18 includes radially outwardly extending fins 24. The fins 24 extend by a predefined distance such that the drive plug 18 fits within the roller tube and able to transmit a rotational force or torque thereto.

As the above-described control end is well known in the art, it has not been described in detail herein. Nevertheless, a skilled person is aware of how such a control end may be constructed and operated. Examples of such control ends may be obtained from Louver-Lite Limited of Cheshire, United Kingdom for example.

The drive wheel and drive plug 18 are secured to the housing 20 by a centre pin 6, which in turn is fixed at one end to the housing 20. The opposite end of the centre pin 6 terminates in a pair of resiliently deformable opposed arms which may be deflected inwards to allow location of the drive plug 18 about the drive shaft of the drive wheel. When the drive plug 18 is correctly located in position, the arms spring back to their rest position and outwardly projecting lugs located at the distal ends of the arms engage an end face of the drive plug 18 and prevent axial movement of the drive plug 18 away from the housing 20.

The centre pin 6 includes a hollow cylindrical body between the fixed end portion and the arms.

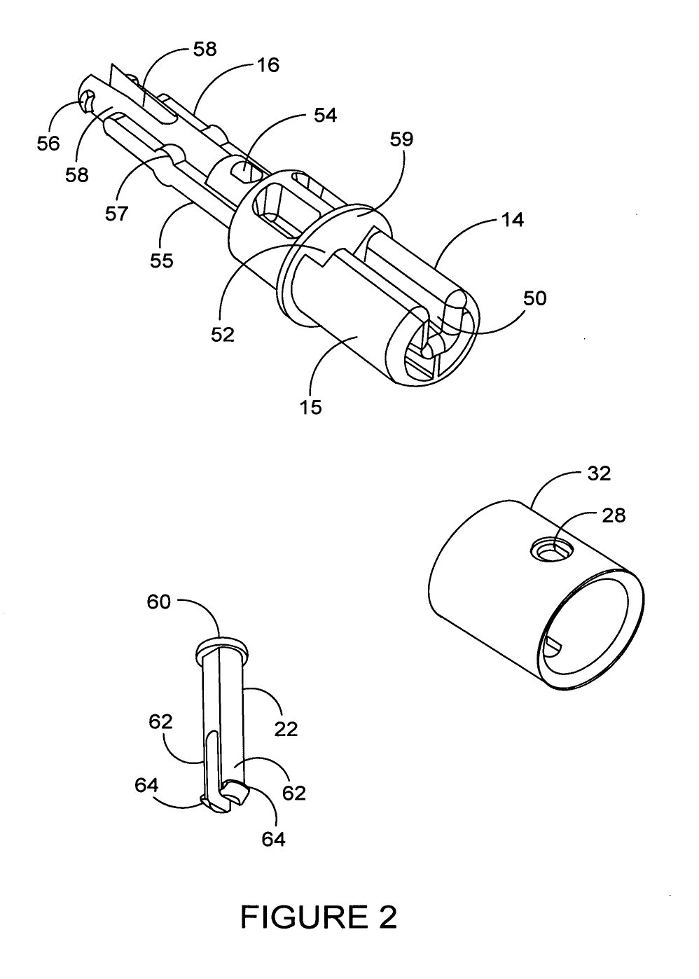

The centre pin 6 is fixed to the housing 20 in such a way that rotation of the centre pin relative to the housing is prevented. The centre pin 6 thus forms the retaining element of the window blind assembly. A stationary end of the spring assembly which comprises the energy storage system in this embodiment is attached to the centre pin 6 by a centre pin connector 14, shown in more detail in FIG. 2.

The centre pin connector 14 has located at one end thereof a pin engagement portion 16 which terminates with a pair of resiliently deformable engagement arms 58. The engagement portion 16 includes a pair of locating ribs 55 which are shaped and sized to fit between the opposed arms of the centre pin 6. To aid the correct engagement of the centre pin connector 14 with the centre pin 6, the ribs each include a transverse protrusion 57 configured to fit snugly within corresponding rebates (not shown) provided within the arms of the centre pin 6. Furthermore, the distal ends of the engagement arms 58 include outwardly extending lugs 56 which are capable of engaging a respective channel formed within the inwardly facing wall of the hollow cylindrical body of the centre pin 6.

To prevent the centre pin connector 14 from being forced out of engagement with the centre pin 6 when the energy storage system is charged, the centre pin connector 14 includes a securing assembly comprising a collar 32 slidably coupled to the engagement portion 16. When the centre pin connector 14 is correctly engaged with the centre pin 6, the collar is adapted to be located such that to overlies at least a part of the engagement arms 58 of the engagement portion 16 of the connector 14 and at least part of the arms of the centre pin 6, and is securable in place by a retaining pin 22. The retaining pin 22 is configured such that it is capable of being inserted through a first aperture 28 in the collar 32, through an aligned aperture 54 which extends through the engagement portion 16 and through a second aperture (not shown) in the collar 32, which is located opposite the first aperture 28. The retaining pin 22 includes a flared head portion 60 which rests against the collar 32 in use, but is unable to pass through either the first or second apertures, and a pair of resiliently deformable opposed arms 62, each of which includes at the distal end thereof a lug 64. The lugs are arranged to be capable of engaging an outwardly facing surface of the collar 32.

At the opposite end of the centre pin connector 14 is a spring engagement portion 15 which includes an axial channel 50 defined along a cylindrical body portion of the spring engagement portion 15.

Located between the spring engagement portion 15 and the centre pin engagement portion 16 is a radially extending flange 59. The flange 59 defines one wall of a circumferential channel 52, the other wall of which is defined by the cylindrical body of the spring engagement portion 15. The axial channel 50 opens at one thereof into the circumferential channel 52, the other end of the channel being co-terminus with the end of the cylindrical body of the spring engagement portion 15.

The circumferential channel 52 is closed by end walls such that the circumferential channel extends about 90° about the longitudinal axis of the connector 14. That is to say, the circumferential channel 52 prescribes an arc about the longitudinal axis of the connector 14, the arc extending through 90°0.

The drive coupling 12 includes a spring connector portion 23 which is arranged similarly to the spring engagement portion 15 of the centre pin connector 14. That is to say, it includes a generally cylindrical body having defined therein an axial channel (not shown) and a flange which is formed from an end wall of a tube engagement portion 25, which extends radially away from the spring connector portion 23 and has a greater diameter than the cylindrical body. A circumferential channel (not shown), similar to the circumferential channel 52 is provided between the body of the spring connector portion and the tube engagement portion 25. The tube engagement 25 includes radially outwardly extending fins 26. The fins 26 extend by a predefined distance such that the drive coupling 12 fits within the roller tube, is capable of sliding axially therein and the fins 26 are capable of engaging with inwardly projecting elements of the roller tube, such that rotation of the drive coupling 12 relative to the roller tube is prevented.

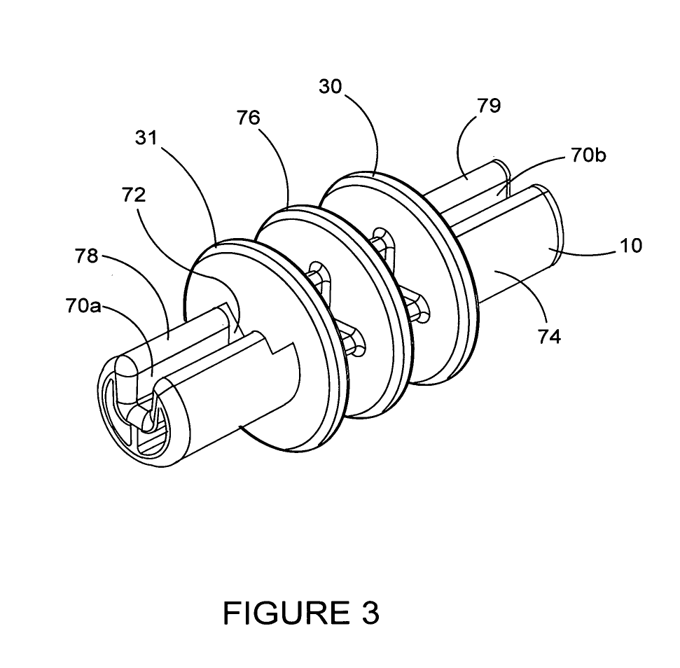

The spring connector 10 (shown in more detail in FIG. 3) includes a generally cylindrical body 74 having extending radially therefrom three flanges 30, 31, 76. The flanges 30, 31, 76 are mutually spaced apart, but are grouped together about the mid-point of the body 74, and they each have an identical diameter. Both end portions 78, 79 of the body 74 have defined therein a respective axial channel 70a, 70b. A circumferential channel 72, similar to those described above, is provided in end portion 78 adjacent the flange 31. Likewise, a corresponding circumferential channel (not shown) is provided in end 79 adjacent the flange 30. Thus, connector 10 is symmetrical about its central flange 76. The axial channels 70a, 70b each open into the respective circumferential channel.

To assemble the roller blind, the two springs 8 are connected to each other at their adjacent ends via the connector 10. This is achieved by sliding one of the inwardly projecting end portions 34 of each spring along the respective axial channel 70a, 70b until it is located within the corresponding circumferential channel adjacent the relevant flange 30, 31. The connector is then rotated by about 45°, whereupon the inwardly projecting end portions 34 of the springs 8 are located within one of the circumferential channels, but out of alignment with their respective axial channel 70a, 70b. Thus, the springs 8 are no longer capable of axial movement relative to the connector 10 or each other.

The inwardly projecting end portion 34 of each spring contacts an end wall of the relevant circumferential channel upon rotation of either the spring 8 or the connector 10. In this way, a rotational force applied to one of the springs 8 is transmitted via the connector 10 to the other spring 8, such that both springs 8 rotate upon the application of a rotational force to one of them and they both store a fraction of the energy being imparted. Accordingly, the springs 8 are connected in series and they each store a part of the energy imparted to the system as a whole.

Of course, more than two springs 8 may be connected in this way.

The two free ends of the spring system are then coupled respectively to the spring engagement portion 15 of the centre pin connector 14 and the cylindrical body of the drive coupling 12 using similar “slide and lock” techniques. Thus the inwardly projecting end portions at the free ends of the spring system are located in the respective circumferential channels in the centre pin connector 14 and the drive coupling 12.

The centre pin connector 14 is then connected to the centre pin 6 by aligning the locating ribs 55 with the gaps between the arms of the centre pin 6 and urging the engagement portion 16 into the opening defined between the arms of the centre pin 6. When fully inserted, the transverse protrusions 57 are located within the corresponding rebates defined in the arms of the centre pin 6 and the lugs 56 of the engagement portion 16 are located within the circumferential channel formed in the inwardly facing surface of the hollow centre pin body.

The collar 32 of the securing assembly is then slid towards the housing 20 until the opposed apertures 28 in the collar align with the aperture 54 through the centre pin connector 14 and is prevented from further axial movement by insertion of the retaining pin 22 through the aligned apertures. The retaining pin 22 is held in place by the snap-fit action of its resiliently deformable arms 62 and their associated lugs 64.

The collar 32 prevents the arms of the centre pin 6 and the arms 58 of the connector 14 being urged apart by the energy stored in the spring system. As the arms of the centre pin 6 and the arms 58 are unable to be deflected outwardly, the connector 14 is prevented from being unintentionally decoupled from the centre pin 6.

The assembly is then inserted into a roller tube. The roller tube includes inwardly projecting elements which engage with the fins 24, 26 of the drive plug 18 and drive coupling 12 respectively. In this way, the rotation of the drive plug 18 causes the roller tube to rotate, which in turn causes the drive coupling 12 to rotate and so charges the spring system with energy.

In use, the control end 4, drive plug 18, roller tube and drive coupling 12 form the charging assembly; the centre pin 6 forms the retaining element; and the two springs 8 connected by the connector 10 form the energy storage system.

From a starting point of the blind substrate being fully wound onto the roller tube (i.e. the blind being in a fully open state), the energy storage system is charged by rotating the drive wheel using a chain or cord to lower or close the blind. The operation of the chain or cord releases the clutch and drives the drive wheel to rotate. This causes the drive plug 18 to rotate, which in turn causes the roller tube and drive coupling 12 to rotate. The drive coupling 12 is connected to one end of the spring system such that relative rotation is prevented. Accordingly, rotation of the drive coupling results in rotation of one end of the spring system. As the other end of the spring system is connected to the centre pin and is prevented from rotating, the drive end of the spring system rotated relative to the fixed end of the spring system. This relative rotation charges the spring system with potential energy.

When the blind is in the desired position, the operator stops rotating the cord or chain which stops rotation of the drive wheel and the clutch is automatically engaged to prevent any further rotation of the roller tube.

When the blind is desired to be raised (i.e. opened), the operator rotates the operating chain or cord in the opposite sense which rotates the drive wheel in the opposite sense. As the drive wheel is being rotated, the clutch is released and the roller tube is free to rotate with the drive wheel. The energy stored in the spring system is released as the blind is raised, thus assisting the raising of the blind by requiring the operator to apply less force than they would otherwise have needed to apply.

The flanges 30, 31, 76 of the connector 10 space the body of the connector 10 and the springs from the inside of the roller tube, thereby eliminating or reducing any noise caused by the springs 8 hitting the inwardly facing surface of the roller tube during rotation of the roller tube.

The skilled person will appreciate that the inwardly projecting elements of the roller tube may not all project by the same distance, thus providing the roller tube with an asymmetric interior. To address this situation, it is possible to provide one or more annular spacers around the or each connector 10. Each spacer acts as a bearing for a respective connector 10 and includes channels in its outwardly facing surface to receive therein the inwardly projecting elements of the roller tube, and provides a central aperture within which may be located the connector, the central aperture being co-axial with the longitudinal axis of the roller tube such that the connector is arranged co-axially with the roller tube. Thus, irrespective of the configuration of the inwardly projecting elements of the roller tube, the spring system is able to rotate about the axis of the roller tube by virtue of the connectors being journalled within the spacers acting as bearings.

What is claimed is:

1. A window blind assembly for use with a roller blind, the assembly comprising:
a charging element;
a retaining element; and
an energy storage system operatively connected therebetween,
wherein the energy storage system comprises a plurality of springs and the charging system is adapted to rotate relative to the retaining element such that the energy storage system is charged upon closure of the blind and the stored energy is released during the opening of the blind, whereby the opening of the blind is assisted by the release of the stored energy from the energy storage system; characterised in that the springs are connected in series such that they are axially spaced from each other and adjacent ends of the springs are connected together via a connector located therebetween, wherein the adjacent ends of the springs are each coupled to a respective end of the connector and rotation of one spring relative to the other is prevented.

2. A window blind assembly according to claim 1, wherein the or each connector comprises a body portion and two end portions, wherein the end portions are each adapted to engage an end of a respective spring.

3. A window blind assembly according to claim 2, wherein each spring includes a pair of opposed ends and each end is provided with an engagement element adapted to engage a respective end portion of the connector.

4. A window blind assembly according to claim 3, wherein the spring is a helical spring comprising a winding, the engagement elements being formed from projecting end portions of the winding.

5. A window blind assembly according to claim 1, wherein the charging assembly further comprises a winding mechanism operatively connected to a drive end of the energy storage system such that the winding mechanism is capable of rotating the drive end of the energy storage system; and a clutch having a first configuration in which the rotation of the drive end of the energy storage system is impeded and a second configuration in which the drive end of the energy storage system is free to rotate.

6. A window blind assembly according to claim 1, wherein the energy storage system is housed within a tubular housing.

7. A window blind assembly according to claim 6, wherein the housing forms part of the charging assembly and operatively connects a winding mechanism to a drive end of the energy storage system.

8. A connector for use with the window blind assembly as claimed in claim 1, the connector comprising a body portion and two opposed end portions, the end portions being adapted to engage an engagement element of a respective spring such that relative rotation of adjacent springs connected by the connector is prevented.

9. A connector according to claim 8, wherein the body portion includes at least one spacer element to space the end portions of the connector from a tubular housing capable of housing the window blind assembly.
